(19) United States
(12) Patent Application Publication
(10) Pub. No.: US 2014/0376050 A1
(43) Pub. Date: Dec. 25, 2014

(54) INFORMATION TERMINAL APPARATUS, METHOD OF CONTROLLING INFORMATION TERMINAL APPARATUS, AND STORAGE MEDIUM

(71) Applicant: CANON KABUSHIKI KAISHA, Tokyo (JP)

(72) Inventor: Tatsuru Baba, Kawasaki-shi (JP)

(21) Appl. No.: 14/311,118

(22) Filed: Jun. 20, 2014

(30) Foreign Application Priority Data
Jun. 24, 2013 (JP) 2013-131634

(51) Int. Cl. H04N 1/00

(52) U.S. Cl. CPC H04N 1/00408; H04N 1/00251; H04N 1/00307; H04N 1/00236; H04N 2201/0041; H04N 2201/006; H04N 2201/0096; H04N 2201/0084; H04N 2201/0094
USPC 358/1.15

(57) ABSTRACT

An information terminal apparatus that is wirelessly communicable with an information processing apparatus enables a user to position an antenna of the information processing apparatus with which the information terminal apparatus communicates and an antenna of the information terminal apparatus with ease by watching a screen of the information terminal apparatus.

### BACKGROUND

1. Field

Aspects of the present invention generally relate to an information terminal apparatus configured to wirelessly communicate with an information processing apparatus, a method of controlling an information terminal apparatus, and a storage medium.

2. Description of the Related Art

Conventional image forming apparatuses have provided an authentication function to control use of the image forming apparatuses by a user. One example is a method that uses a radio frequency identification (RFID) tag. In this method, an image forming apparatus including a tag reader/writer reads information from an RFID tag that has been brought into close proximity to the image forming apparatus, and then executes authentication based on the information.

Meanwhile, application of near field communication (NFC) technology to mobile terminals such as smartphones and tablet personal computers (PC) has started. The NFC technology is one of the near field wireless communication methods. The NFC specification defines three functions. The first one is a reader/writer function that enables an operation that is similar to the operation of the tag reader/writer. The second one is a card emulation function that enables execution of an operation that is similar to the operation of the RFID tag. The third one is a pear-to-pear function that enables transmission and reception of various types of data through NFC. An NFC function-installed mobile terminal includes a reader/writer and uses it to read or write data from or on an RFID card or an NFC card. Thus, when the NFC function-installed mobile terminal writes authentication data on an NFC card emulation block included in an image forming apparatus, a function that is similar to user authentication using an RFID tag can be realized.

One of the features of the NFC is the physical distance in which communication can be established. The physical distance varies depending on the size of an NFC communication antenna, influences of material of a component disposed near an NFC communication antenna, etc., but is about 10 cm. Therefore, in order to establish NFC communication between a mobile terminal and an image forming apparatus, NFC communication antennas of the mobile terminal and the image forming apparatus need to be brought into proximity to each other, about no greater than 10 cm.

A mobile terminal includes a user interface to which a touch panel called a liquid crystal display (LCD) is attached. The user interface is provided with a front surface of the mobile terminal, so an NFC communication antenna is attached to a rear surface of the mobile terminal. Among the mobile terminals, tablet PCs have a large housing size because they include a large LCD.

For example, the housing size of a tablet PC that includes a 10.1 LCD is about 20 cm×27 cm. This requires the user to recognize the position of the NFC communication antenna provided with the rear surface of the tablet PC and consciously bring it into proximity to the NFC communication antenna of the image forming apparatus. However, since the tablet PC has a large housing size, the NFC communication antenna of the image forming apparatus can hide behind the housing of the tablet PC to be out of the user's view, making it difficult for the user to bring the NFC communication antenna of the tablet PC into proximity to the NFC communication antenna of the image forming apparatus.

There is a technique for bringing a communication antenna into proximity at a position that is out of the user's view. According to the technique, a camera and a marker are provided to establish a near field communication based on the position of the marker that is captured by the camera (refer to, for example, Japanese Patent Application Laid-Open No. 2010-226945). Mobile terminals include a camera, so the technique can be applied when an NFC communication antenna is to be brought into proximity.

However, the technique is directed to two-dimensional antenna positioning, while three-dimensional positioning is required to bring an NFC communication antenna of a mobile terminal into proximity to a communication antenna of an image forming apparatus. Furthermore, the positions of a camera and an NFC communication antenna differ in each mobile terminal, and there may be a case in which the camera and the NFC communication antenna are positioned apart from each other.

In this case, while the NFC communication antenna of the mobile terminal is brought into proximity to an NFC communication antenna of an image forming apparatus, the NFC communication antenna of the image forming apparatus may be moved outside a shooting range of the camera of the mobile terminal.

### SUMMARY

According to an aspect of the present invention, an information terminal apparatus wirelessly communicable with an information processing apparatus includes an image capturing unit, a display unit configured to display an image captured by the image capturing unit, a storage unit configured to store image information indicating a position of a communication antenna provided with the information processing apparatus, a determination unit configured to determine whether an image captured by the image capturing unit and displayed on the display unit includes the image information stored in the storage unit, and a display control unit configured to, when the determination unit determines that the image includes the image information stored in the storage unit, highlight a position of the image information of the information processing apparatus displayed on the display unit.

Further features of the present disclosure will become apparent from the following description of exemplary embodiments with reference to the attached drawings.

### BRIEF DESCRIPTION OF THE DRAWINGS

FIG. 1 illustrates a configuration of a print system to which an information processing apparatus is applied.

FIG. 2 is a block diagram illustrating a configuration of an image forming apparatus illustrated in FIG. 1.

FIG. 3 is a block diagram illustrating a configuration of a mobile terminal illustrated in FIG. 1.

FIG. 4 illustrates an exterior of the image forming apparatus illustrated in FIG. 1.

FIGS. 5A and 5B respectively illustrate an exterior of the mobile terminal illustrated in FIG. 1.

FIG. 6 is a flow-chart illustrating a method of controlling an information terminal apparatus.

FIG. 7 is a flow-chart illustrating a method of controlling an information terminal apparatus.

FIGS. 8A, 8B, and 8C are perspective views each illustrating an operation example of the mobile terminal illustrated in FIG. 1.

FIG. 9 illustrates a configuration of an information processing apparatus.

FIGS. 10A and 10B respectively illustrate an installation position of an NFC antenna installed in the mobile terminal illustrated in FIG. 9.

FIG. 11, which is composed of FIG. 11A and FIG. 11b, is a flow-chart illustrating a method of controlling an information terminal apparatus.

FIGS. 12A, 12B, and 12C illustrate images of positioning of an NFC antenna installed in a mobile terminal.

FIG. 13, which is composed of FIG. 13A and FIG. 13B, is a flow-chart illustrating a method of controlling an information terminal apparatus.

### DESCRIPTION OF THE EMBODIMENTS

Various exemplary embodiments will be described in detail below with reference to the drawings.

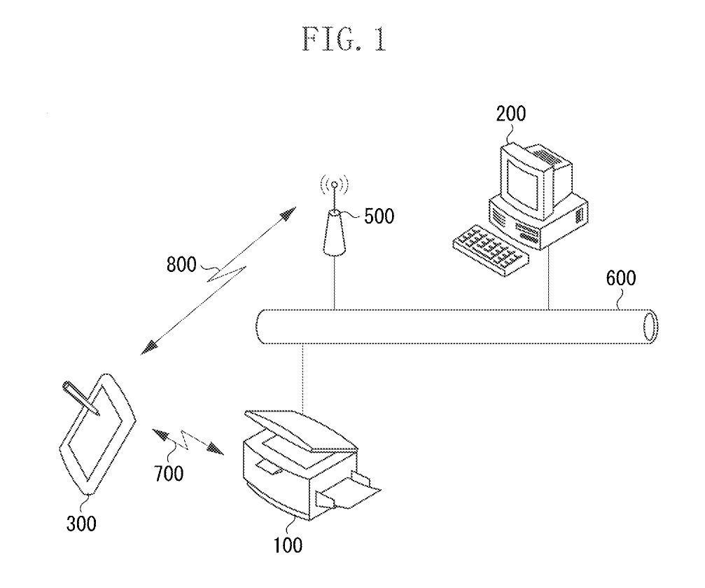

FIG. 1 illustrates a configuration of a print system to which an information terminal apparatus according to the present exemplary embodiment is applied. This shows an example of a system including an image forming apparatus 100, which is an example of an information processing apparatus, a personal computer 200, a mobile terminal 300, a wireless local area network (LAN) access point 500, and a LAN 600. The image forming apparatus 100 described below may include a printing apparatus.

In FIG. 1, the image forming apparatus 100 has a copy function, a print function, and a scan function. The image forming apparatus 100 also has a user authentication function for use of the above functions.

The user authentication uses an authentication card (not illustrated) that records user identification (ID) information. The image forming apparatus 100 receives via an NFC communication 700 the user ID information stored in the authentication card (not illustrated), and executes user authentication based on a database (not illustrated) for authentication that is stored in the image forming apparatus 100.

Alternatively, a server (not illustrated) configured to store user ID information and execute authentication processing can be provided to execute the authentication processing via the local area network 600.

The personal computer 200 can send a print job to the image forming apparatus 100, and refer to data computerized by the image forming apparatus 100.

The mobile terminal 300 is a portable information processing terminal having functions including the NFC communication 700, wireless LAN communication 800, etc. Examples include smartphones and tablet PCs.

The mobile terminal 300 can communicate with the image forming apparatus 100 via the NFC communication 700. Examples include transmission and reception of an Internet Protocol (IP) address, transmission of user ID information, etc. Further, the mobile terminal 300 can execute printing of image data stored in the mobile terminal 300 by transmitting the image data to the image forming apparatus 100 via the wireless LAN communication 800.

The wireless LAN access point 500 has a function to enable communication between the mobile terminal 300 having a wireless LAN interface and the like and devices connected to the local area network 600. While the wireless communication interface in the present exemplary embodiment uses the system configuration using the wireless LAN, any other wireless communications technologies such as Bluetooth® can be used. The local area network 600 is a network connection realized by Ethernet® or the like. The image forming apparatus 100, the personal computer 200, and the wireless LAN access point 500 are connected one another via the local area network 600.

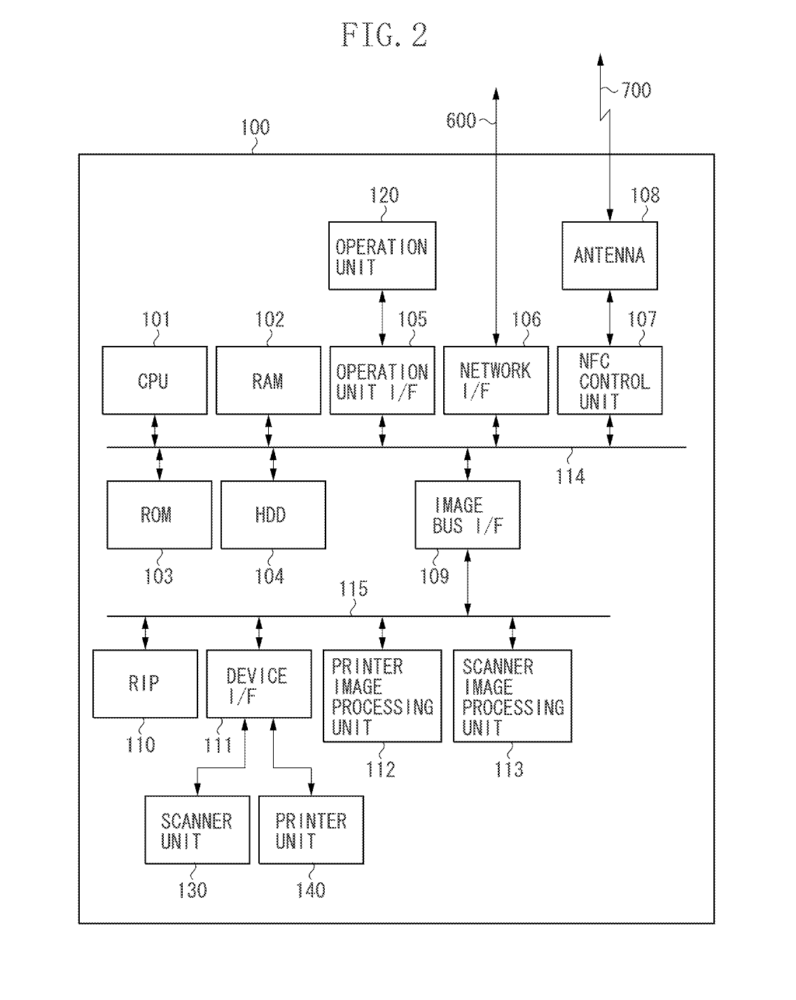

FIG. 2 is a block diagram illustrating a configuration of the image forming apparatus 100 illustrated in FIG. 1.

In FIG. 2, a central processing unit (CPU) 101 controls the entire image forming apparatus 100. A random-access memory (RAM) 102 is a work memory for temporarily storing data for use in calculation by the CPU 101. A read-only memory (ROM) 103 stores a program for use to activate the image forming apparatus 100, and is used mainly at the time of activating the image forming apparatus 100. A hard disk drive (HDD) 104 stores software for the control of the image forming apparatus 100, various settings, saved documents, etc.

An operation unit 120 is for inputting and outputting information between the image forming apparatus 100 and a user. An operation unit interface (I/F) 105 is an interface for operating the operation unit 120 and relays data that is to be input to and output from the operation unit 120.

A network I/F 106 is an interface for sending and receiving data to and from an external device via the local area network 600. An NFC control unit 107 executes control to perform NFC communication. An antenna 108 is an antenna for performing NFC communication. The antenna 108 sends and receives radio waves generated in the NFC communication with an external device. The CPU 101, the RAM 102, the ROM 103, the HDD 104, the operation unit I/F 105, the network I/F 106, and the NFC control unit 107 are connected to one another via a system bus 114. An image bus I/F 109 performs a relay between the system bus 114 and an image bus 115, which connects each block configured to perform image processing. The image bus I/F 109 also performs data structure conversion. A raster image processor (RIP) 110, a device I/F 111, a printer image processing unit 112, and a scanner image processing unit 113 are connected to the image bus 115.

The RIP 110 converts a page description language (PDL) code or display list into a bitmap image. The device I/F unit 111 is an interface for connecting a scanner unit 130 and a printer unit 140 to the image bus 115.

The device I/F 111 performs timing adjustment for sending to the image bus 115 image data received from the scanner unit 130. The device I/F 111 also performs timing adjustment for sending image data from the image bus 115 to the printer unit 140. The scanner unit 130 performs processing such as correction according to the image forming apparatus 100 and resolution conversion on image data generated by a scanner sensor. The printer unit 140 performs processing such as correction according to a print engine of the image forming apparatus 100 and resolution conversion on image data to be print output.

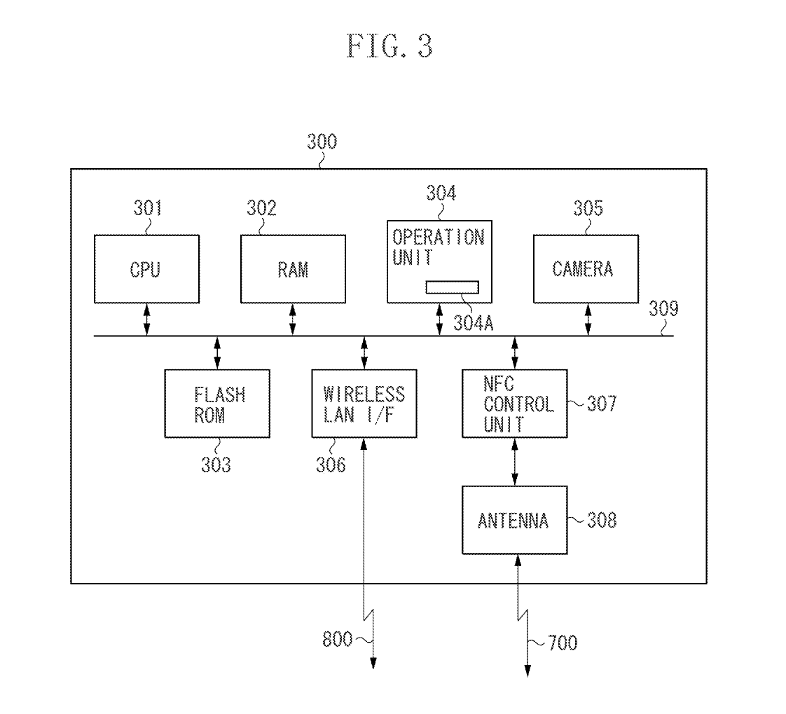

FIG. 3 is a block diagram illustrating a configuration of the mobile terminal 300 illustrated in FIG. 1.

In FIG. 3, a CPU 301 controls the entire mobile terminal 300. A RAM 302 is a work memory for temporarily storing data for use in calculation by the CPU 301. A flash ROM 303 stores programs and various types of data for use by the CPU 301.

An operation unit 304 is for inputting and outputting information between a user and the mobile terminal 300. The operation unit 304 includes a LCD and touch panel. A camera 305 is for shooting still images and moving images. A wireless LAN I/F 306 is an interface for sending and receiving data to and from an external device via the wireless LAN communication 800.

An NFC control unit 307 executes control to perform the NFC communication 700. An antenna 308 is for performing the NFC communication 700. The antenna sends and receives radio waves generated in the NFC communication 700 with an external device. The CPU 301, the RAM 302, the flash ROM 303, the operation unit 304, the camera 305, the wireless LAN I/F 306, and the NFC control unit 307 are connected to one another via a system bus 309 to send and receive data from one another. The operation unit 304 includes a display screen 304A in the form of a touch panel. The display screen 304A displays images captured by a camera 305 as a shooting unit (or an image capturing unit).

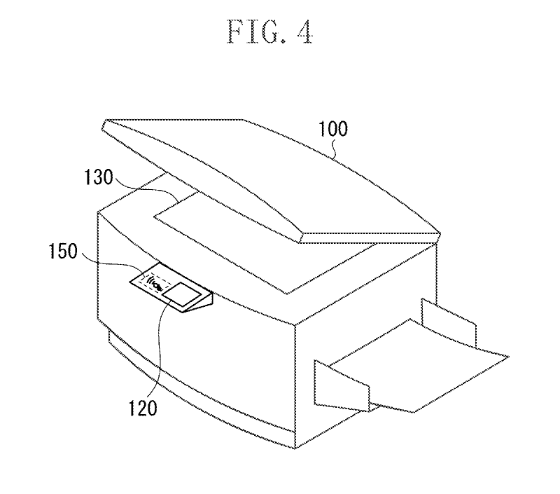

FIG. 4 illustrates an exterior of the image forming apparatus 100 illustrated in FIG. 1.

In FIG. 4, the operation unit 120 and an NFC antenna mark 150 (specific mark image information) are provided on a front surface of the image forming apparatus 100. The NFC antenna mark 150 indicates an installation position of the antenna 108. On a top surface of the image forming apparatus 100 is provided a scanner unit 130. While the image forming apparatus 100 in the first exemplary embodiment includes the antenna 108 and the NFC antenna mark 150 in the operation unit 120, the configuration is not limited to that of the first exemplary embodiment.

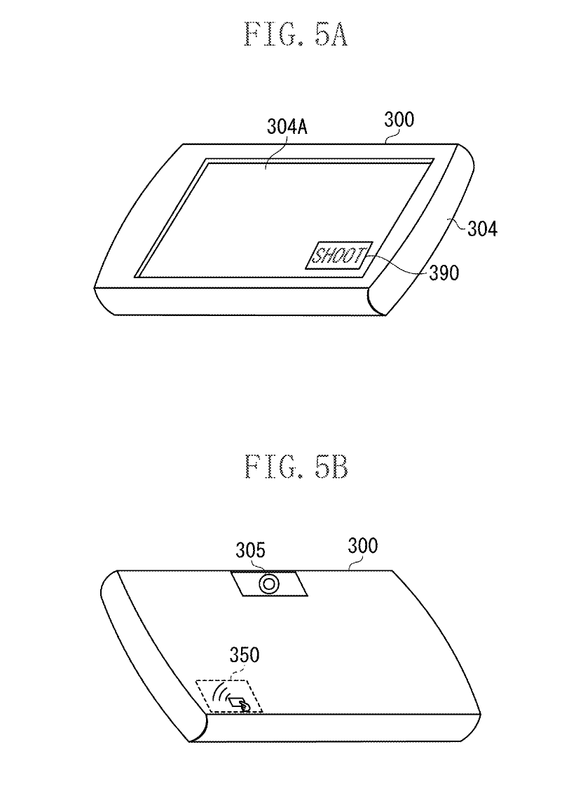

FIGS. 5A and 5B respectively illustrate an exterior of the mobile terminal 300 illustrated in FIG. 1.

FIG. 5A is a front view of the mobile terminal 300 including the operation unit 304. The operation unit 304 displays a shooting button 390. The shooting button 390 used in the first exemplary embodiment is displayed on the operation unit 304 under the condition that a specific application is executed, etc., and is operable with a touch panel (not illustrated). Alternatively, a physical button can be prepared, and the function can be assigned to the physical button.

FIG. 5B is illustrates the mobile terminal 300 viewed from the back where the camera 305 and an NFC antenna mark 350 are provided. The NFC antenna mark 350 indicates an installation position of the antenna 308. While the camera 305 and the NFC antenna mark 350 are positioned apart from each other in the mobile terminal 300 according to the first exemplary embodiment as illustrated in FIG. 5B, the positions of the camera 305 and the NFC antenna mark 350 are not limited to those in the first exemplary embodiment.

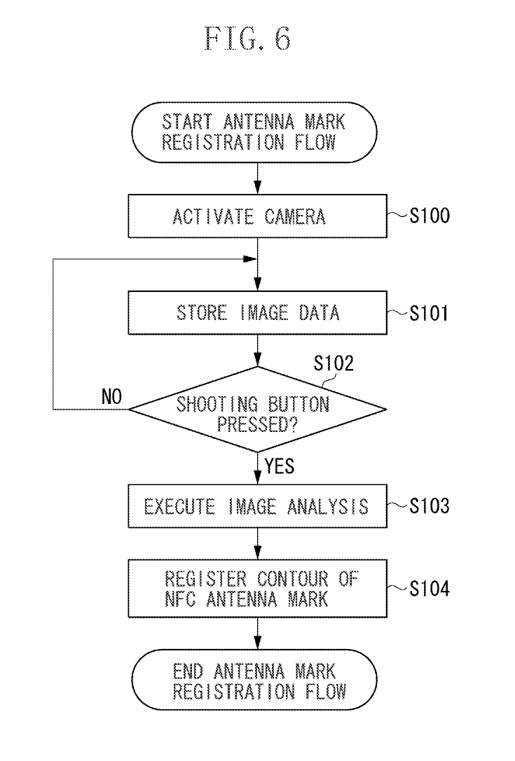

FIG. 6 is a flowchart illustrating a method of controlling the information terminal apparatus according to the present exemplary embodiment. This is an example of processing to register in the mobile terminal 300 the NFC antenna mark 150 included in the image forming apparatus 100. The CPU 301 executes a control program stored in the flash ROM 303 to realize each step. Specifically, an application for the registration of the NFC antenna mark 150 is provided in the mobile terminal 300, and a user executes the application to perform the processing. This, however, is not to limit the configuration of the application to one. Similar processing can be realized by a plurality of applications, or a user operation can substitute a part to realize similar processing. Further, the CPU 301 in the mobile terminal 300 is to execute the application(s).

In step S100, the CPU 301 activates the camera 305 of the mobile terminal 300. In step S101, the RAM 302 in the mobile terminal 300 stores image data captured by the camera 305 of the mobile terminal 300. In step S102, the user presses the shooting button 390 of the camera 305 provided with the mobile terminal 300 while observing an image displayed on the operation unit 304. When the CPU 301 determines that the shooting button 390 is not pressed (NO in step S102), the process returns to step S101, and the RAM 302 continues to store image data captured by the camera 305.

In step S103, the CPU 301 executes image analysis on the stored image data to extract a feature of the NFC antenna mark 150. The image analysis in the first exemplary embodiment uses processing such as binarization and edge extraction to extract mainly a contour of the NFC antenna mark 150, but is not limited to a particular image analysis method.

In step S104, the CPU 301 registers the extracted contour of the NFC antenna mark 150 in the database (not illustrated), and then ends the processing.

While the database (not illustrated) in the first exemplary embodiment is prepared in the RAM 302 or the flash ROM 303 in the mobile terminal 300, the database can be prepared in an external server (not illustrated) or the like outside the mobile terminal 300.

The process for the registration of the NFC antenna mark 150 of the image forming apparatus 100 in the mobile terminal 300 in FIG. 6 does not have to be performed in the case of using a pre-registered NFC antenna mark 150.

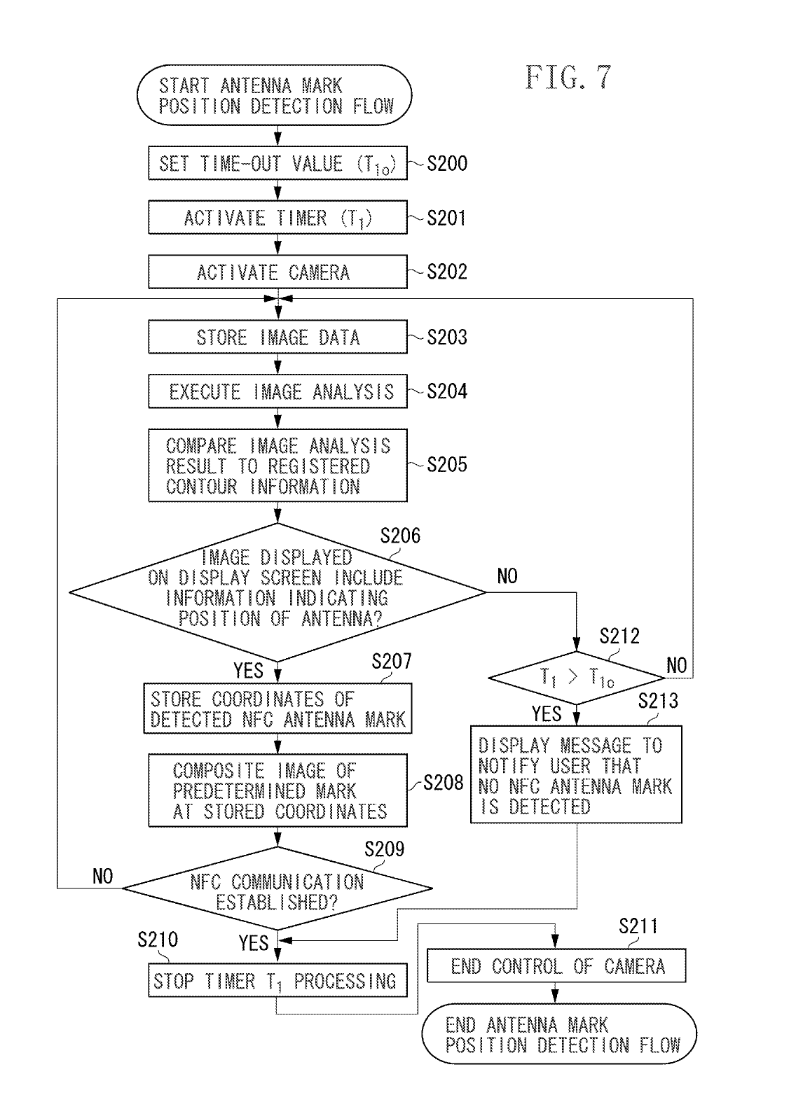

FIG. 7 is a flowchart illustrating a method of controlling the information terminal apparatus according to the present exemplary embodiment. This is an example of processing to detect the position of the NFC antenna provided with the image forming apparatus 100. The CPU 301 executes a control program stored in the flash ROM 303 to realize each step. The following describes display control by which, when the CPU 301 determines that image information indicating the position of the antenna is included, a display unit of the operation unit 304 displays the image information such that the position of the image information is highlighted.

As to the process flow illustrated in FIG. 7, an application for detecting the position of the NFC antenna is prepared in the mobile terminal 300, and a user executes the application so that the process flow is executed. This, however, is not to limit the configuration of the application to one. Similar processing can be realized by a plurality of applications, or a user operation can substitute a part to realize similar processing.

In step S200, the CPU 301 sets a time-out value T₁ₒ for a timer T₁. In step S201, the CPU 301 activates the timer T₁. In step S202, the CPU 301 activates the camera 305 of the mobile terminal 300. In step S203, image data captured by the camera 305 of the mobile terminal 300 is stored in the RAM 302 in the mobile terminal 300. In step S204, the CPU 301 executes image analysis on the image data stored in the RAM 302 to detect the NFC antenna mark 150. The image information stored in the RAM 302 corresponds to the image information that is captured by the shooting unit (camera 305), and indicates the position of the communication antenna to be provided with the information processing apparatus (image forming apparatus 100).

The image analysis in the present exemplary embodiment uses processing such as binarization and edge extraction to extract mainly a contour of the NFC antenna mark 150 but is not limited to a particular image analysis method.

In step S205, the CPU 301 compares information about the obtained result of the image analysis to pre-registered contour information about the NFC antenna mark 150. In step S206, the CPU 301 determines whether the image displayed on the display screen includes information that indicates the position of the antenna. While the comparison to the contour information in the present exemplary embodiment uses processing such as template matching using an approximation, the method is not limited to a particular image matching method.

When the CPU 301 determines that the NFC antenna mark 150 is detected in the image data stored in the RAM 302 (YES in step S206), then in step S207, the CPU 301 stores coordinates of the NFC antenna mark 150 detected in the image data stored in the RAM 302. While the coordinate information in the present exemplary embodiment uses an address of the RAM 302, any other information can also be used.

In step S208, the CPU 301 composites an image of a predetermined mark at the stored coordinates. The shape and size of the mark are not particularly limited. The mark can be in the shape of a circle or a cross, and can have any size that is large enough to enable the user to see.

In step S209, the CPU 301 determines whether the NFC communication 700 is established. Whether the NFC communication 700 is established can be determined by a check of a resistor (not illustrated) that indicates the state of the NFC control unit 307. When the CPU 301 determines that the NFC communication 700 is not established (NO in step S209), the process returns to step S203, and the CPU 301 causes the camera 305 to capture an image again and stores the obtained image data in the RAM 302.

On the other hand, when the CPU 301 determines that the NFC communication 700 is established (YES in step S209), then in step S210, the CPU 301 stops the timer T₁ processing. In step S211, the CPU 301 ends the control of the camera 305.

In step S206, on the other hand, when the CPU 301 determines that no NFC antenna mark 150 is detected in the image data stored in the RAM 302 (NO in step S206), then in step S212, the CPU 301 compares the timer T₁ to the time-out value T₁ₒ.

When the CPU 301 determines that the timer T₁ is not greater than the time-out value T₁ₒ (NO in step S212), the process returns to step S203, and the CPU 301 causes the camera 305 to capture an image again and stores obtained image data in the RAM 302.

On the other hand, when the CPU 301 determines that the timer T₁ is greater than the time-out value T₁ₒ (YES in step S212), then in step S213, the CPU 301 displays a message on the operation unit 304 to notify the user that no NFC antenna mark 150 is detected. Then, the process proceeds to step S210, and the CPU 301 stops the timer T₁ processing. In step S211, the CPU 301 stops the control of the camera 305 and ends the processing.

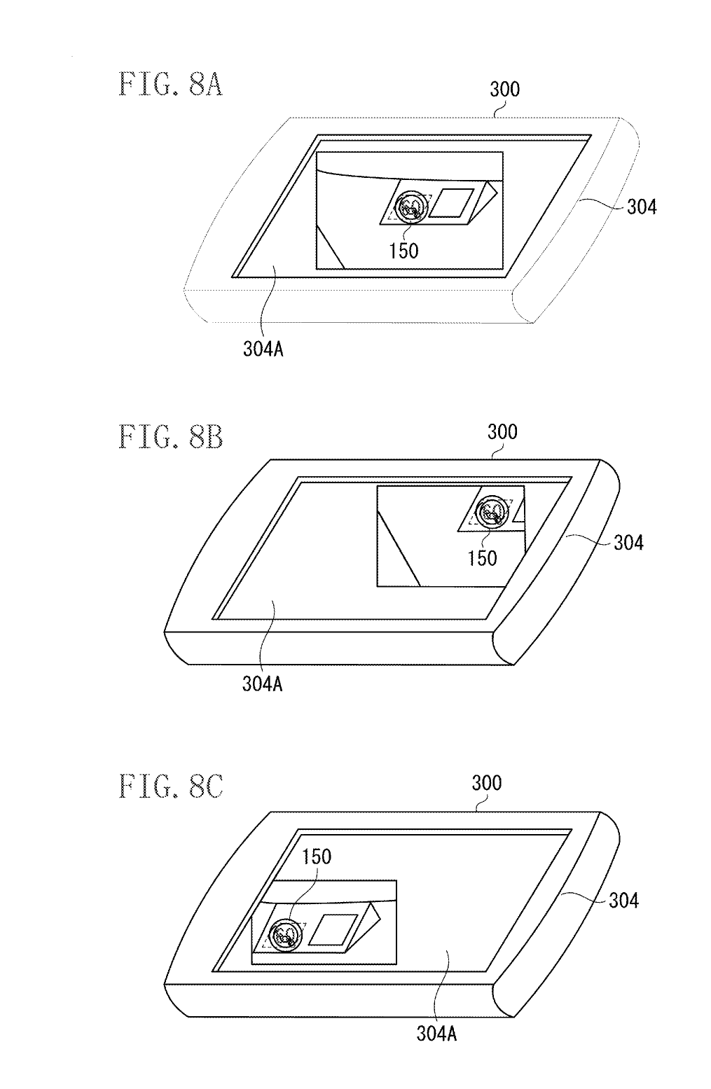

FIGS. 8A, 8B, and 8C are perspective views each illustrating an operation example of the mobile terminal 300 illustrated in FIG. 1. Each example illustrates a user operation and shows that the NFC antenna mark 150 of the image forming apparatus 100 is displayed on the operation unit 304 of the mobile terminal 300.

In FIGS. 8A, 8B, and 8C, each circle added to the NFC antenna mark 150 of the image forming apparatus 100 that is displayed on the operation unit 304 of the mobile terminal 300 indicates the processing result of the NFC antenna position detection flow illustrated in FIG. 7.

The antenna 308 of the mobile terminal 300 in the present exemplary embodiment is disposed at the lower right portion of the mobile terminal 300. FIG. 8A illustrates the state in which the NFC antenna mark 150 of the image forming apparatus 100 is positioned on a straight line extending from the camera 305 of the mobile terminal 300. In this case, the user can bring the mobile terminal 300 into proximity to the image forming apparatus 100 by moving the mobile terminal 300 to the upper left.

FIG. 8B illustrates the state in which the NFC antenna mark 150 of the image forming apparatus 100 exists at a position that is slightly shifted to the right from the straight line extending from the camera 305 of the mobile terminal 300. In this case, the user can bring the mobile terminal 300 into proximity to the image forming apparatus 100 by moving the mobile terminal 300 rather widely to the upper left.

FIG. 8C illustrates the state in which the NFC antenna mark 150 of the image forming apparatus 100 exists at a position that is slightly shifted to the lower left from the straight line extending from the camera 305 of the mobile terminal 300. In this case, the user can directly bring the mobile terminal 300 into proximity to the image forming apparatus 100.

The foregoing processing enables the user to position the antennas with ease by looking at the screen.

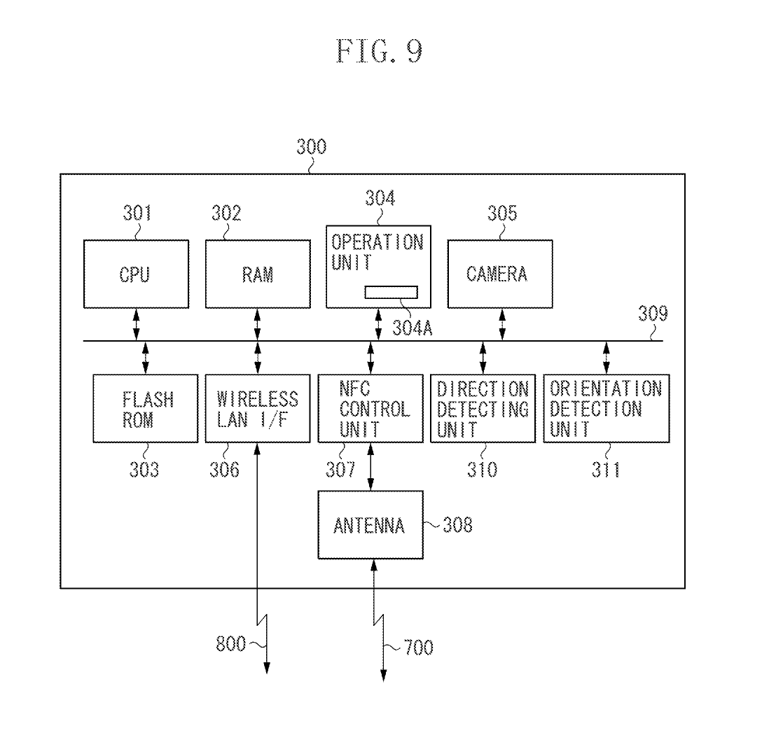

FIG. 9 illustrates a configuration of the information processing apparatus according to a second exemplary embodiment. The components that are similar to those illustrated in FIG. 3 are given the same reference numerals. The following describes features of the present exemplary embodiment using the mobile terminal 300 as an example of the information processing apparatus.

In FIG. 9, a direction detecting unit 310 and an orientation detection unit 311 are added to the configuration illustrated in FIG. 3. The direction detecting unit 310 detects a direction toward which the mobile terminal 300 is currently directed by use of a geomagnetic sensor or the like. The orientation detection unit 311 detects whether the user is holding the mobile terminal 300 vertically or horizontally by use of an acceleration sensor or the like. The present exemplary embodiment will describe an exemplary case where the orientation detection unit 311 is used as a detection unit to detect an orientation in which an operator is holding the display unit, and the direction detecting unit 310 is used as a detection unit to detect the direction of the display unit.

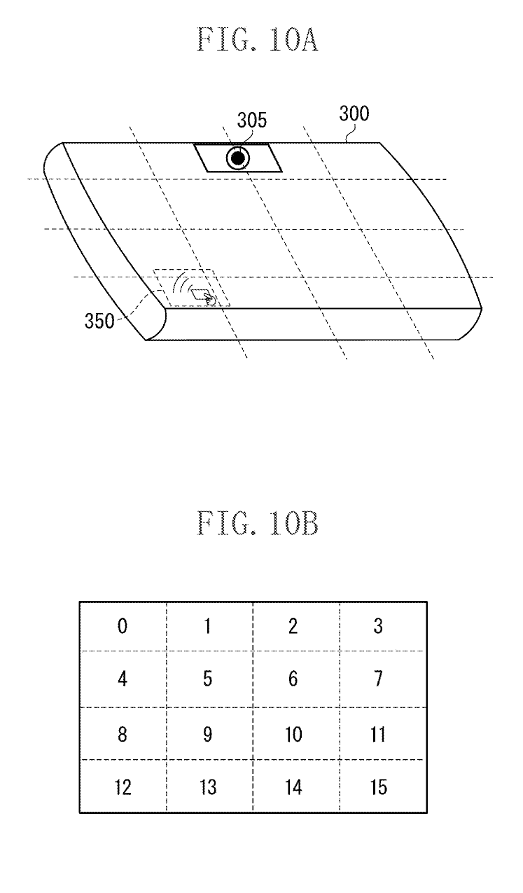

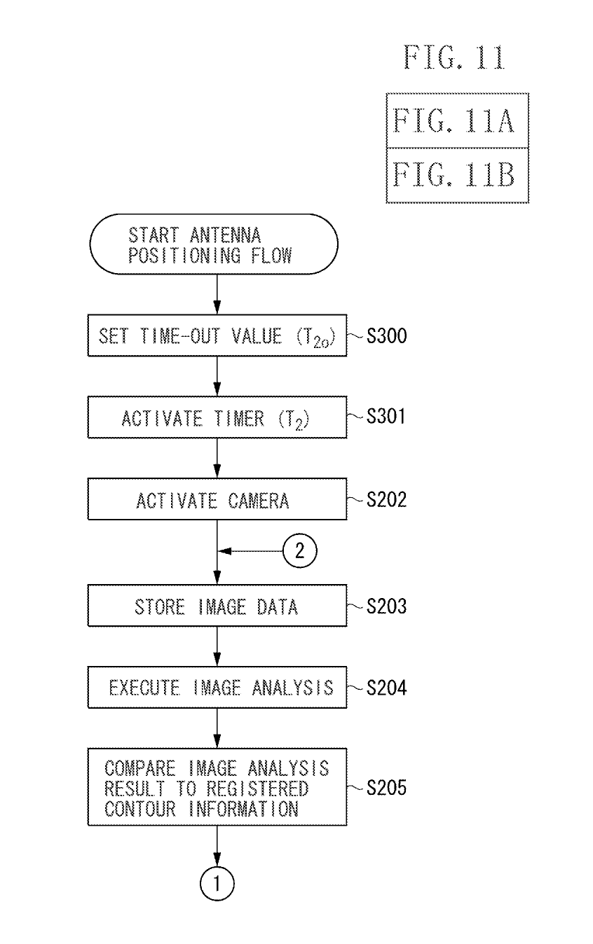

FIGS. 10A and 10B illustrate the installation position of the antenna 308 (as illustrated herein as the NFC antenna mark 350) of the mobile terminal 300 illustrated in FIG. 9.

The installation position of the antenna 308 depends on the mobile terminal 300 but is fixed, because the antenna 308 is hardware. In the present exemplary embodiment, the mobile terminal 300 is divided into 16 blocks, and the block in which the antenna 308 is positioned is stored.

FIG. 10A illustrates the mobile terminal 300 viewed from the back, showing an image of the mobile terminal 300 divided into 16 blocks. FIG. 10B illustrates an image in which an identification number is added to each of the 16 divided blocks.

The installation position of the antenna 308 in FIG. 10A corresponds to the block No. 12 in FIG. 10B, so the block No. 12 is stored as the installation position of the antenna 308.

Since the block numbers are fixed values, the block numbers can be stored in the flash ROM 303 as data attached to an application that is to be operated on the mobile terminal 300. However, the block numbers may be stored in the flash ROM 303 as intrinsic parameters that the mobile terminal 300 have. While the mobile terminal 300 is divided into 16 blocks to indicate the position of the antenna 308 in the second exemplary embodiment, the number of blocks is not limited to 16.

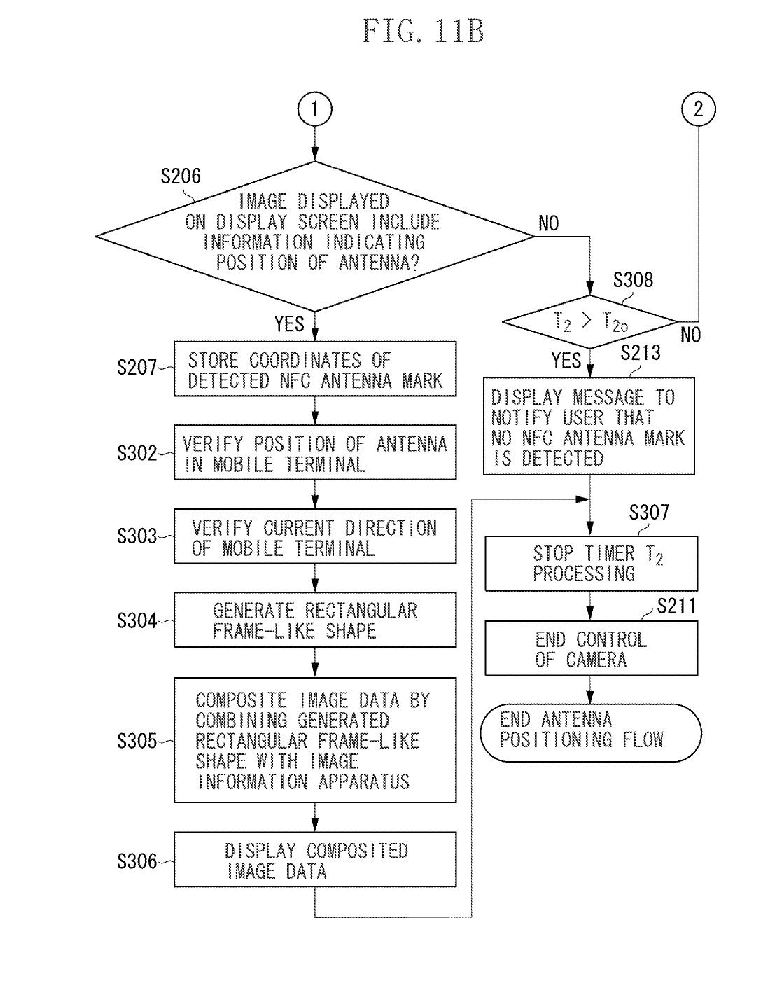

FIG. 11 is a flowchart illustrating a method of controlling the information terminal apparatus according to the present exemplary embodiment. This is an example of processing to display an image in which the antenna 108 of the image forming apparatus 100 and the antenna 308 of the mobile terminal 300 are combined together. The CPU 301 executes a control program stored in the flash ROM 303 to realize each step. The following describes display control by which, when the CPU 301 determines that image information is included, the display unit displays the image information such that the relative positional relationship between the image information and the specified communication unit is highlighted.

As to the process flow illustrated in FIG. 11, an application for displaying on the mobile terminal 300 an image in which the antennas 108 and 308 are combined together, and the user executes the application so that the process flow is executed. This, however, is not to limit the configuration of the application to one. Similar processing can be realized by a plurality of applications, or a user operation can substitute a part to realize similar processing. The CPU 301 in the mobile terminal 300 is to execute the application(s).

In step S300, the CPU 301 sets a time-out value T₂ₒ for a timer T₂. In step S301, the CPU 301 activates the timer T₂. Then, in step S202, the CPU 301 activates the camera 305 of the mobile terminal 300. In step S203, image data captured by the camera 305 of the mobile terminal 300 is stored in the RAM 302 in the mobile terminal 300. In step S204, the CPU 301 executes image analysis on the image data stored in the RAM 302 to detect the NFC antenna mark 150. The image analysis in the present exemplary embodiment uses a method that is similar to the image analysis method used in the first exemplary embodiment.

In step S205, the CPU 301 compares information about the obtained result of the image analysis to the pre-registered contour information about the NFC antenna mark 150. The comparison to the contour information in the present exemplary embodiment uses a process that is similar to the comparison method used in the first exemplary embodiment.

When the CPU 301 determines that the NFC antenna mark 150 is detected in the image data stored in the RAM 302 (YES in step S206), then in step S207, the CPU 301 stores the coordinates of the NFC antenna mark 150 detected in the image data stored in the RAM 302. The coordinate information used in the present exemplary embodiment is similar to the coordinate information used in the first exemplary embodiment.

In step S302, the CPU 301 verifies the position of the antenna 308 in the mobile terminal 300 by reading a parameter stored as the installation position of the antenna 308. In step S303, the CPU 301 verifies the current direction of the mobile terminal 300 from information detected by the direction detecting unit 310 and information detected by the orientation detection unit 311. In step S304, the CPU 301 generates a rectangular frame-like shape based on the image of the mobile terminal 300 from the position of the antenna 308 and the direction information about the mobile terminal 300.

In step S305, the CPU 301 composites image data by combining the generated rectangular frame-like shape with the image forming apparatus 100 based on the position of the antenna 308 of the mobile terminal 300 and the position of the antenna 108 of the image forming apparatus 100. In step S306, the CPU 301 displays the composited image data on the operation unit 304 of the mobile terminal 300. In step S307, the CPU 301 stops timer T₂ processing.

Then, in step S211, the CPU 301 stops the control of the camera 305 and ends the processing.

In step S206, on the other hand, when the CPU 301 determines that no NFC antenna mark 150 is detected in the image data stored in the RAM 302 (NO in step S206), then in step S308, the CPU 301 compares the timer T₂ to the time-out value T₂ₒ.

When the CPU 301 determines that the timer T₂ is not greater than the time-out value T₂ₒ (NO in step S308), the process returns to step S203, and the CPU 301 causes the camera 305 to capture an image again and stores the obtained image data in the RAM 302.

On the other hand, when the CPU 301 determines that the timer T₂ is greater than the time-out value T₂ₒ (YES in step S308), then in step S213, the CPU 301 displays a message on the operation unit 304 to notify the user that no NFC antenna mark 150 is detected. In step S307, the CPU 301 stops the timer T₂ processing. Then, in step S211, the CPU 301 stops the control of the camera 305 and ends the processing.

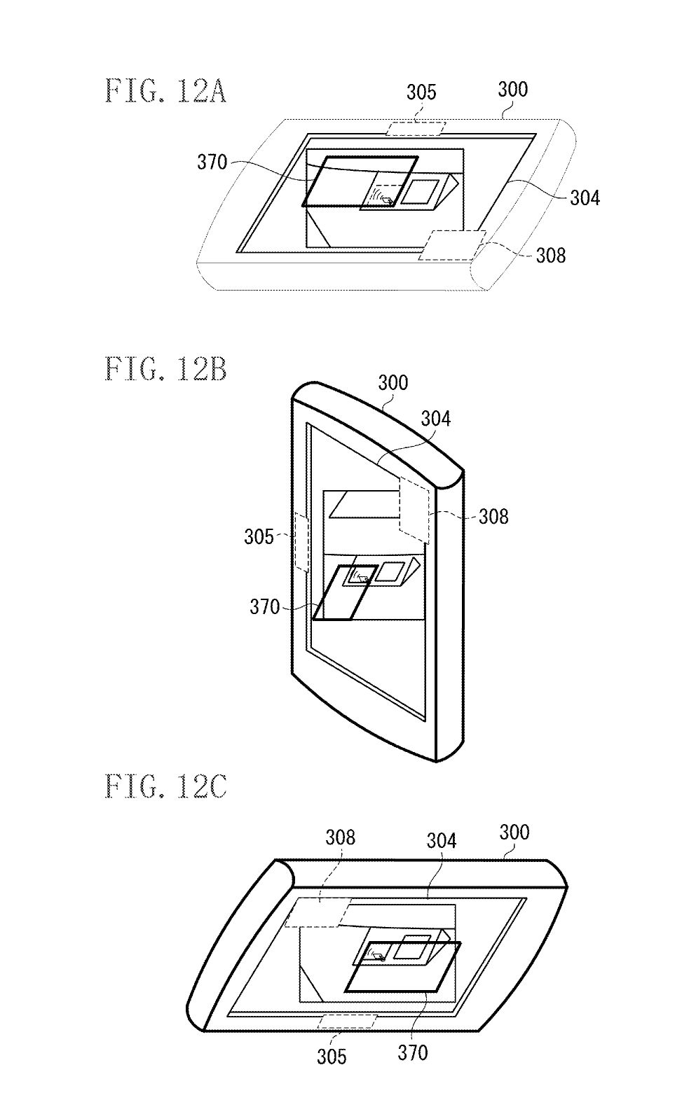

FIGS. 12A, 12B, and 12C illustrate images of positioning of the antenna 108 of the image forming apparatus 100 and the antenna 308 of the mobile terminal 300 illustrated in FIG. 1.

FIG. 12A illustrates the mobile terminal 300 including the camera 305 at the upper center and the antenna 308 at the lower right. FIG. 12A shows an image in which the mobile terminal 300 is displayed as the rectangular frame-like shape 370 on the operation unit 304 of the mobile terminal 300, and the lower right portion of the rectangular frame-like shape 370 overlaps the antenna 108 of the image forming apparatus 100. The present exemplary embodiment describes the case in which the display control is performed such that one corner position of the rectangular frame-like shape 370 overlaps the contour of the information indicating the position of the antenna of the information processing apparatus.

FIG. 12B illustrates the mobile terminal 300 including the camera 305 at the center of the left side and the antenna 308 at the upper right. FIG. 12B shows an image in which the mobile terminal 300 is displayed as the rectangular frame-like shape 370 on the operation unit 304 of the mobile terminal 300, and the upper right portion of the rectangular frame-like shape 370 overlaps the antenna 108 of the image forming apparatus 100.

FIG. 12C illustrates the mobile terminal 300 including the camera 305 at the lower center and the antenna 308 at the upper left. FIG. 12C shows an image in which the mobile terminal 300 is displayed as the rectangular frame-like shape 370 on the operation unit 304 of the mobile terminal 300 and the upper left portion of the rectangular frame-like shape 370 overlaps the antenna 108 of the image forming apparatus 100.

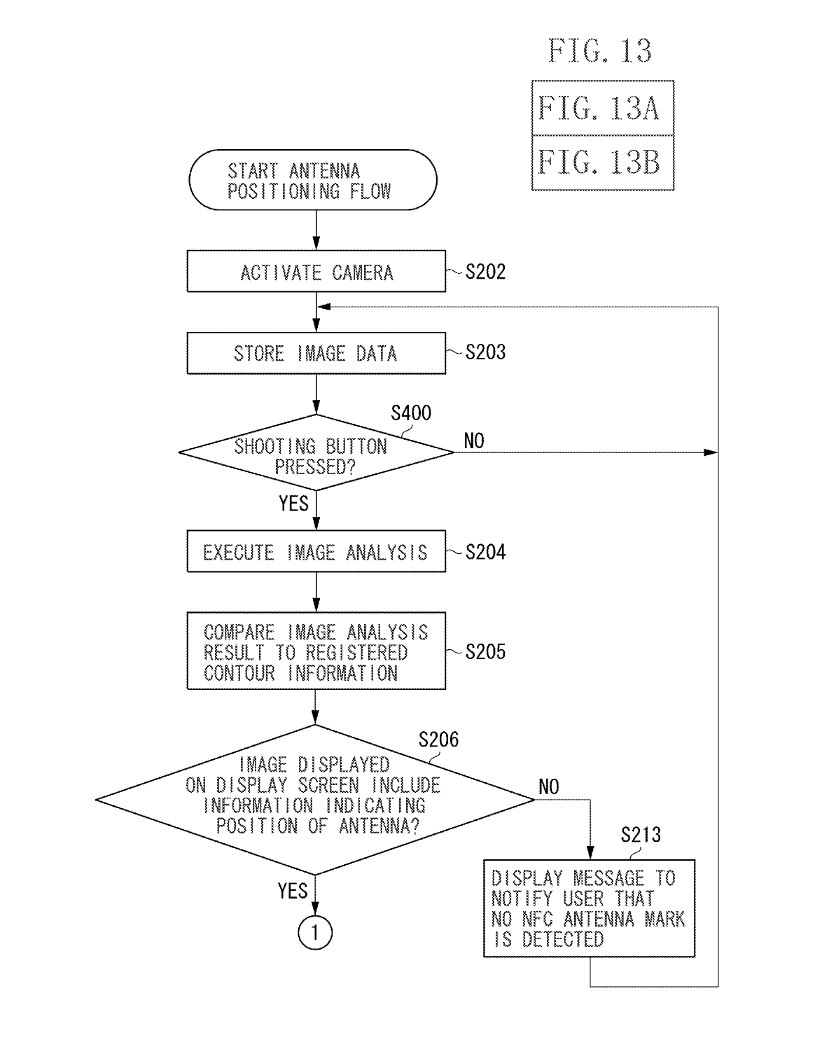

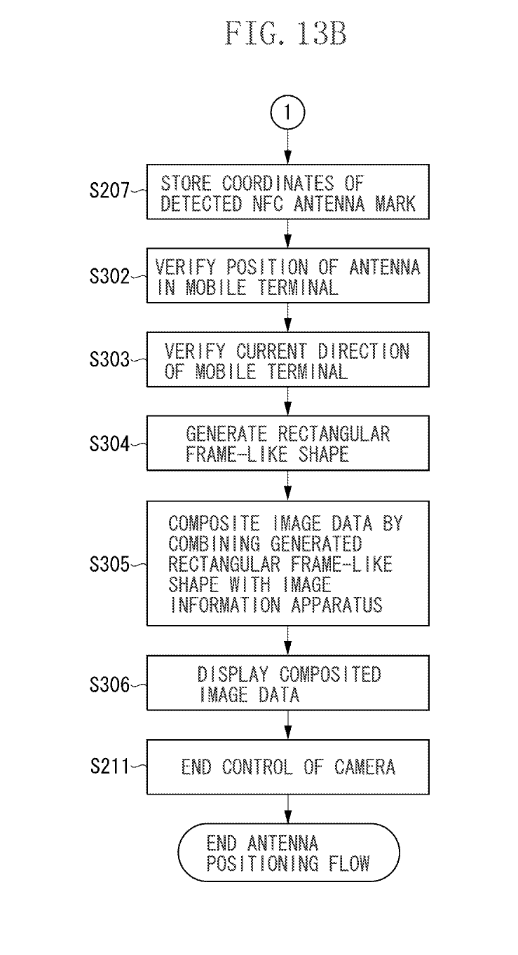

FIG. 13 is a flowchart illustrating a method of controlling the information terminal apparatus according to a third exemplary embodiment. This is an example of processing to display an image in which the antenna 108 of the image forming apparatus 100 and the antenna 308 of the mobile terminal 300 are combined together. The CPU 301 executes a control program stored in the flash ROM 303 to realize each step. A feature of the present embodiment is that a user selects the timing of importing an image into the mobile terminal 300 via the camera 305 in the processing in FIG. 11 according to the second exemplary embodiment. As to the process flow illustrated in FIG. 13, an application for displaying on the mobile terminal 300 an image in which the antennas 108 and 308 are combined together, and the user executes the application so that the process flow is executed. This, however, is not to limit the configuration of the application to one. Similar processing can be realized by a plurality of applications, or a user operation can substitute a part to realize similar processing.

The CPU 301 in the mobile terminal 300 is to execute the application(s).

In step S202, the CPU 301 activates the camera 305 of the mobile terminal 300. In step S203, image data captured by the camera 305 of the mobile terminal 300 is stored in the RAM 302 of the mobile terminal 300. In step S400, while watching an image of the image forming apparatus 100 that is displayed on the operation unit 304 of the mobile terminal 300, the user presses the shooting button 390 at the timing when the user confirms that the NFC antenna mark 150 is displayed on the operation unit 304. When the CPU 301 does not detect pressing of the shooting button 390 (NO in step S400), the CPU 301 repeats the execution of the operation to store in the RAM 302 the image data captured by the camera 305.

On the other hand, when the CPU 301 detects pressing of the shooting button 390 (YES in step S400), then in step S204, the CPU 301 executes image analysis on the image data stored in the RAM 302 to detect the NFC antenna mark 150. The image analysis in the present exemplary embodiment uses a method that is similar to that used in the first and second exemplary embodiments.

In step S205, the CPU 301 compares information about the obtained result of the image analysis to the pre-registered contour information about the NFC antenna mark 150. The comparison to the contour information in the present exemplary embodiment uses a process that is similar to that used in the first and second exemplary embodiments. When the CPU 301 determines that no NFC antenna mark 150 is detected in the image data stored in the RAM 302 (NO in step S206), then in step S213, the CPU 301 displays a message on the operation unit 304 to notify the user that no NFC antenna mark 150 is detected. On the other hand, when the NFC antenna mark 150 is detected in the image data stored in the RAM 302 (YES in step S206), then in step S207, the CPU 301 stores the coordinates of the NFC antenna mark 150 detected in the image data stored in the RAM 302. The coordinate information in the present exemplary embodiment is similar to the coordinate information in the first exemplary embodiment.

In step S302, the CPU 301 verifies the position of the antenna 308 in the mobile terminal 300 by reading a parameter stored as the installation position of the antenna 308. In step S303, the CPU 301 verifies the current direction of the mobile terminal 300 from the information detected by the direction detecting unit 310 and the information detected by the orientation detection unit 311.

In step S304, the CPU 301 generates a rectangular frame-like shape based on the image of the mobile terminal 300 from the position of the antenna 308 and the direction information about the mobile terminal 300. In step S305, the CPU 301 composites image data by combining the generated rectangular frame-like shape with the image forming apparatus 100, based on the position of the antenna 308 of the mobile terminal 300 and the position of the antenna 108 of the image forming apparatus 100.

In step S306, the CPU 301 displays the composited image data on the operation unit 304 of the mobile terminal 300. Then, in step S211, the CPU 301 stops the control of the camera 305 and ends the processing.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-131634 filed Jun. 24, 2013, which is hereby incorporated by reference herein in its entirety.

What is claimed is:

1. An information terminal apparatus wirelessly communicable with an information processing apparatus, the information terminal apparatus comprising:
an image capturing unit;
a display unit configured to display an image captured by the image capturing unit;
a storage unit configured to store image information indicating a position of a communication antenna provided with the information processing apparatus;
a determination unit configured to determine whether an image captured by the image capturing unit and displayed on the display unit includes the image information stored in the storage unit; and
a display control unit configured to, when the determination unit determines that the image includes the image information stored in the storage unit, highlight a position of the image information of the information processing apparatus displayed on the display unit.

2. The information terminal apparatus according to claim 1, wherein the display control unit performs control such that the image information displayed on the display unit and specific mark image information are combined together to be displayed by highlighting the position of the communication antenna.

3. An information terminal apparatus wirelessly communicable with an information processing apparatus, the information terminal apparatus comprising:
an image capturing unit;
a display unit configured to display an image captured by the image capturing unit;
a storage unit configured to store image information indicating a position of a communication antenna provided with the information processing apparatus;
a determination unit configured to determine whether an image captured by the image capturing unit and displayed on the display unit includes the image information stored in the storage unit; and
a display control unit configured to, when the determination unit determines that the image includes the image information stored in the storage unit, display a position at which the information terminal apparatus should be set.

4. The information terminal apparatus according to claim 3, wherein the display control unit performs control such that the position at which the information terminal apparatus should be set is displayed in a shape of a rectangle.

5. A method of controlling an information terminal apparatus wirelessly communicable with an information processing apparatus, the method comprising:
displaying an image captured by an image capturing unit;
storing image information indicating a position of a communication antenna provided with the information processing apparatus;
determining whether an image captured by the image capturing unit and displayed includes the stored image information; and
performing control such that, when it is determined that the image includes the stored image information, the position of the image information of the information processing apparatus that is displayed is highlighted.

6. A computer-readable storage medium storing computer-executable instructions for causing a computer to execute a method of controlling an information terminal apparatus wirelessly communicable with an information processing apparatus, the method comprising:
displaying an image captured by an image capturing unit;
storing image information indicating a position of a communication antenna provided with the information processing apparatus;
determining whether an image captured by the image capturing unit and displayed includes the stored image information; and
performing control such that, when it is determined that the image includes the stored image information, the position of the image information of the information processing apparatus that is displayed is highlighted.
